(19) United States
(12) Patent Application Publication
(10) Pub. No.: US 2026/0320036 A1
(43) Pub. Date: Oct. 15, 2026

(54) NATURAL LANGUAGE MULTI-DATABASE QUERY PROCESSING

(71) Applicant: NVIDIA Corporation, Santa Clara, CA (US)

(72) Inventors: Abhishek Anurag, Pune (IN); Nisha Rao, Pune (IN); Neeraj Pandey, Pune (IN)

(21) Appl. No.: 19/176,037

(22) Filed: Apr. 10, 2025

(51) Int. Cl. G06F 16/242; G06F 16/2452; G06F 16/248; G06F 16/28

(52) U.S. Cl. CPC G06F 16/243; G06F 16/24522; G06F 16/248; G06F 16/285

(57) ABSTRACT

In some examples, apparatuses, systems, methods, processors, and techniques are described that use one or more machine learning models to perform natural language queries involving two or more data sources (e.g., databases, data lakes, etc.). For example, two or more data sources may be identified as storing data potentially responsive to a natural language query (e.g., a prompt), and two or more database sub-queries are obtained based at least on the natural language query. The database sub-queries are used to obtain results from the identified data sources, and the obtained data is mapped to a data structure, such as a table, to present the results from the data sources correlated based on the natural language query.

### BACKGROUND

To obtain data from multiple different types of databases, users must use advanced search features, search bars, or Representational State Transfer (REST) application programing interface (APIs) to individually query separate databases. Each query typically requires domain-specific knowledge, such as knowledge of the database schema and specific query syntax, to apply filters effectively to obtain desired data. Further, users are typically required to manually integrate data from the various sources, which is time-consuming and error-prone. In many cases, users need to query multiple different types of databases individually and manually align, merge, and customize data to extract meaningful insights. For at least these reasons, methods of querying multiple databases can be improved.

### SUMMARY

Embodiments of the present disclosure relate to a natural language multi-database query processing. Systems and methods are disclosed that use one or more machine learning models to identify different databases using a natural language query (e.g., a prompt), generate two or more database sub-queries based at least on the natural language query, and present data obtained using the database sub-queries.

In contrast to conventional systems, the systems and methods disclosed herein use machine learning models to generate multiple natural language sub-queries for multiple databases based on a natural language query. The systems and methods disclosed herein then convert the natural language sub-queries into database specific syntax, and obtain the desired results. The systems and methods disclosed herein further, in some cases, output the retrieved data according to the semantic structure and/or relationships between different data of the query, such as by combining the retrieved data into one or more data structures or tables, for example, to output data the maintains correlations between multiple databases.

### BRIEF DESCRIPTION OF THE DRAWINGS

The present systems and methods for natural language multi-database query processing are described in detail below with reference to the attached drawing figures, wherein:

FIG. 1 illustrates a block diagram of an example system, in accordance with at least one embodiment;

FIG. 2 illustrates a block diagram showing an example process for performing a database query using machine learning, in accordance with at least one embodiment;

FIG. 3 illustrates a block diagram of an example data flow for performing a database query on multiple databases using machine learning, in accordance with at least one embodiment;

FIG. 4 illustrates an example process for performing a database query using machine learning, in accordance with at least one embodiment;

FIG. 5 illustrates an example of a system including software and hardware to query one or more databases using machine learning, according to at least one embodiment;

FIG. 6 illustrates an example system to use one or more application programming interfaces (APIs) to query one or more databases using machine learning, according to at least one embodiment;

FIG. 7A is a block diagram of an example generative language model system suitable for use in implementing at least some embodiments of the present disclosure;

FIG. 7B is a block diagram of an example generative language model that includes a transformer encoder-decoder suitable for use in implementing at least some embodiments of the present disclosure;

FIG. 7C is a block diagram of an example generative language model that includes a decoder-only transformer architecture suitable for use in implementing at least some embodiments of the present disclosure;

FIG. 8 is a block diagram of an example computing device suitable for use in implementing at least some embodiments of the present disclosure; and

FIG. 9 is a block diagram of an example data center suitable for use in implementing at least some embodiments of the present disclosure.

### DETAILED DESCRIPTION

Systems and methods are disclosed related to natural language multi-database query processing. For example, multiple databases may be queried by providing a natural language prompt to one or more machine learning processes. The described systems and processes use one or more machine learning models to identify databases in a natural language query (e.g., a prompt), convert the natural language query into two or more natural language query sub-queries, translate the sub-queries into the relevant syntax, and use the sub-queries to obtain desired data from the two or more databases. In some aspects, the data obtained via the database sub-queries may be output in a structure that is based on the natural language query, such as via a fusion table or other data structure. In some cases, the described machine learning assisted approach enables users to query data from multiple sources without needing technical or domain-specific expertise, such as fluency in query syntax or query language(s) required by the individual databases and/or knowledge of the structure of the databases, to compose individual queries for each database. In various examples, the described techniques may provide a better and/or more efficient utilization of computing resources, such as including faster processing time to access data from multiple databases, reducing manual user input needed to obtain desired results from multiple databases, and reducing computing resources (e.g., network bandwidth) to obtain and organize the data into a usable format by the user. In various implementations, the described systems and processes correlate data from different sources according to the original query, to present the data in a more useful way.

In some embodiments, a query processing system may first obtain a user query (referred to as a main query), such as may be in the form of natural language. The main query may be obtained in the form of text, one or more prompts, speech, or one or more other methods that convey sematic information. The query processing system may perform a database query process (e.g., implemented by a DBQuery Analyzer or other similar component) that may decompose the main query into sub-queries, and based on the semantic data included in the sub-queries, identify relevant databases to search. In some embodiments, the database query process may use one or more machine learning models to identify the databases referenced in the main query. In some cases, this may include using field or column classification and/or named entity recognition (NER) to identify what data in which databases to search. In some embodiments, the database query process may create an output fusion data structure (e.g., a table) based on column classification data identified from the main query, so that the data obtained from the identified databases can be presented in a format that is responsive to the main query.

The database query process may convert the natural language sub-queries into database queries having appropriate query syntax (e.g., Structed Query Language (SQL)), such that can be processed by the identified databases. The database query process may use one or more machine learning models to convert the sub-queries into the database queries. For example, the system may use one or more language models (LM(s)) (e.g., one or more large language models LLM(s), one or more small language models (SLM(s)), one or more vision language models (VLM(s)), one or more multi-modal language model (MMLM(s)), etc.) such as SoTA (e.g., sqlcoder-7b-2), trained and fine-tuned using on-premise raw data. The database query process may perform the conversion of some or all of the sub-queries in parallel or simultaneously, to improve efficiency.

The database query process then executes the database queries against the identified databases (e.g., in parallel/simultaneously and/or serially, such as based on the column classification or relationship identified between the different requested datasets in the main query). The database query process may then map, merge, customize, and/or format the results according to the main query such as to improve clarity. In some cases, using Llama 2 13B or other LM(s) (e.g., LLM(s), SLM(s), VLM(s), MMLM(s), etc.), the database query process customizes the response data for readability, turning complex database results into accessible insights.

In some cases, users can provide feedback in response to the output generated by the query processing system (e.g., by performing the database query process). In response to such feedback, the query processing system may retrain the database query process, and include the main query and a ground truth response in a training dataset to provide more accurate and concrete output to users. In some cases, the user may select an output type for the data, such as exported in a certain format (e.g., Portable Document Format (pdf), a spreadsheet format, such as that used by Microsoft Excel, a document format, a text format, a database table format, a data structure format, a tabular format, and/or one or more other formats), and/or via specified communication channels (e.g., email, short message service (SMS), messaging application(s), file(s), data stream(s), custom application(s), etc.).

For example, a main query may be submitted to the query processing system that states: “Show me the test cases executed by Neeraj Pandey and any regression bugs found by them in last month?” The database query process (performed by the query processing system) may then decompose this main query into multiple sub-queries, such as by first identifying the different databases referenced in the main query, such as a test results database (or database table(s)) storing test result information and a developer test database (or database table(s)) storing information related to tests performed. The database query process may use field or column classification and/or named entity recognition (NER) to identify what data in which databases to search, such as columns of data corresponding to test case data executed by Neeraj Pandey in the developer test database, and columns of data corresponding to regression bugs corresponding to identified testcases in the test results database. The database query process may then combine the output, such as into a single table that shows testcase data from the developer test database correlated with regression bugs corresponding to the data from the test results database. In some embodiments, the process of combining the outputs may be performed using one or more machine learning models.

In some examples, the one or more of the machine learning model(s) (e.g., deep neural networks, language models, LLMs, SLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, SLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, SLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, SLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), small language models (SLMs), vision language models (VLMs), multi-modal language models (MMLMs), vision-language-action (VLA) models, etc.), and/or other types of machine learning models.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

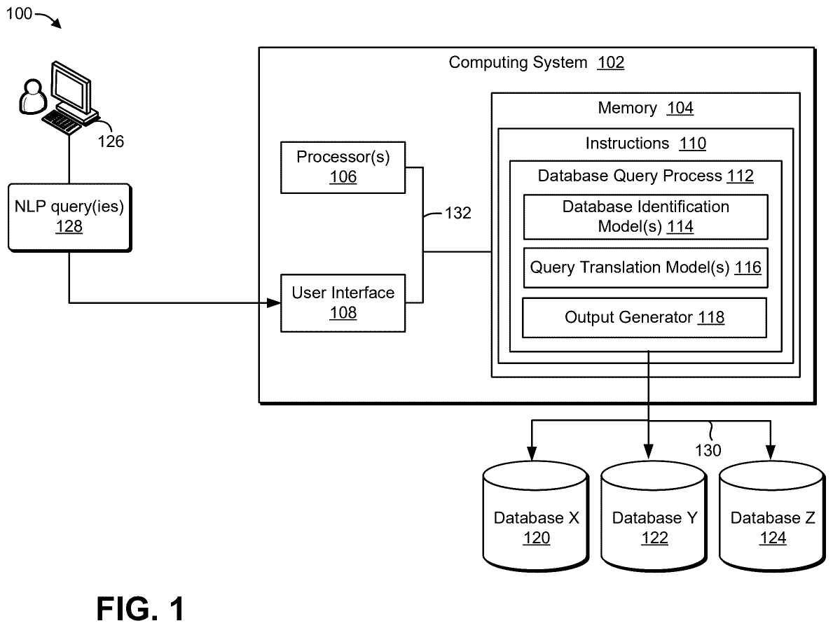

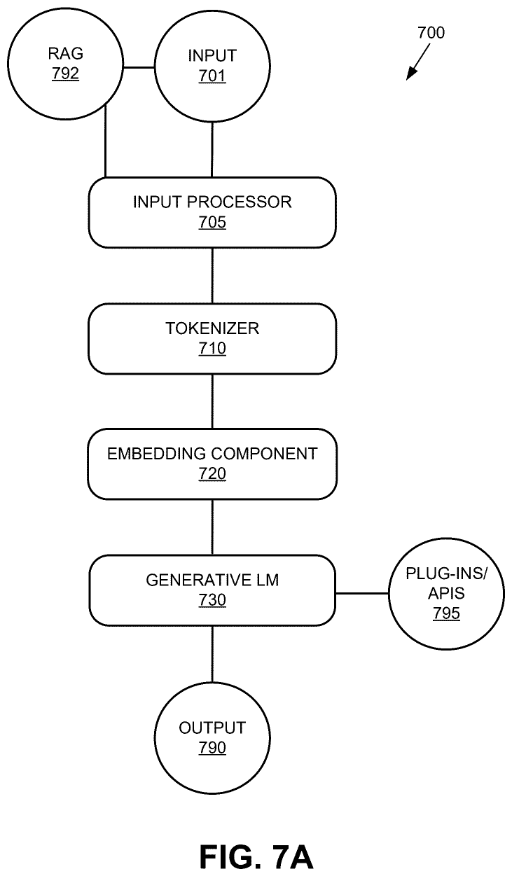

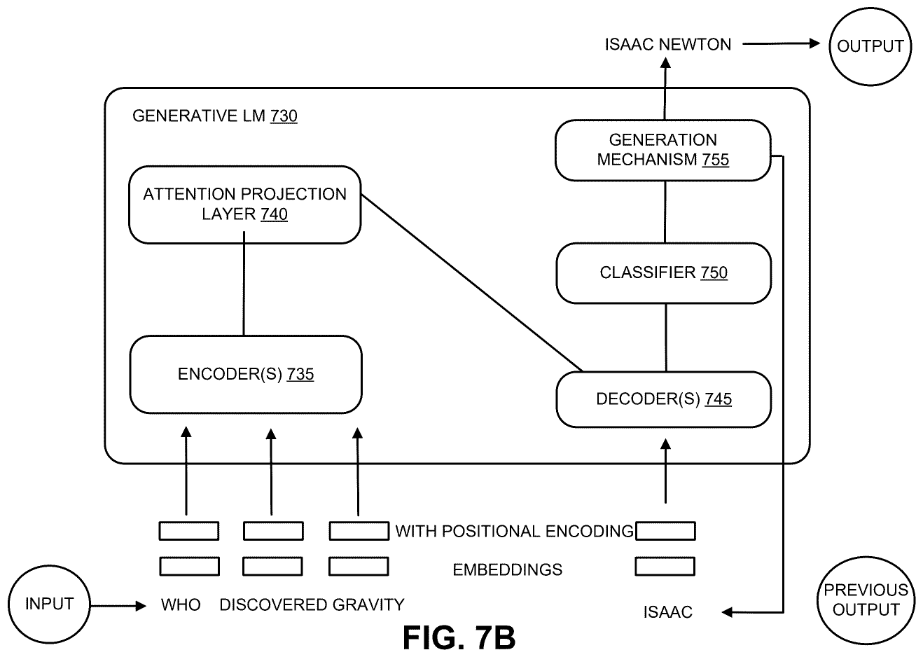

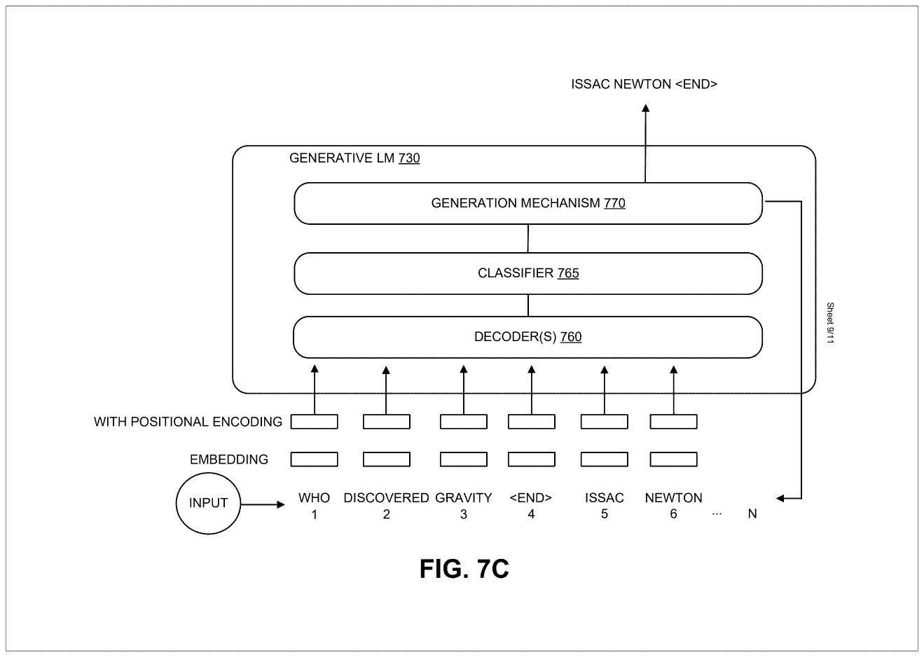

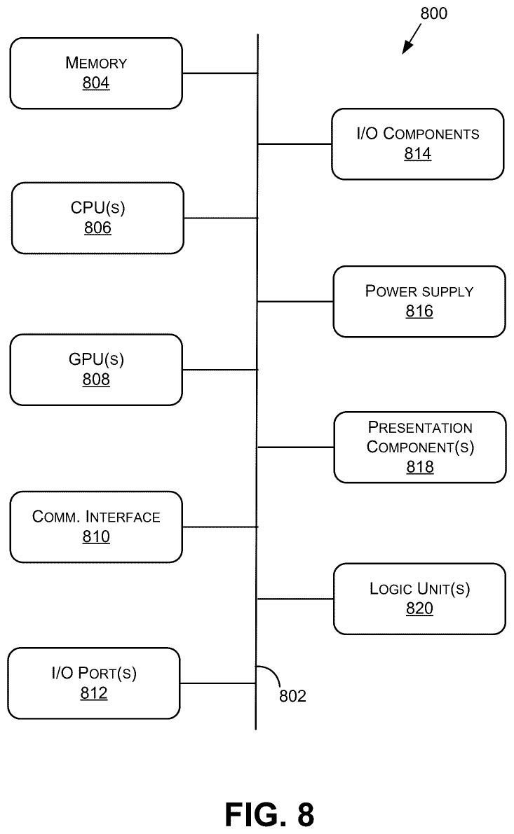

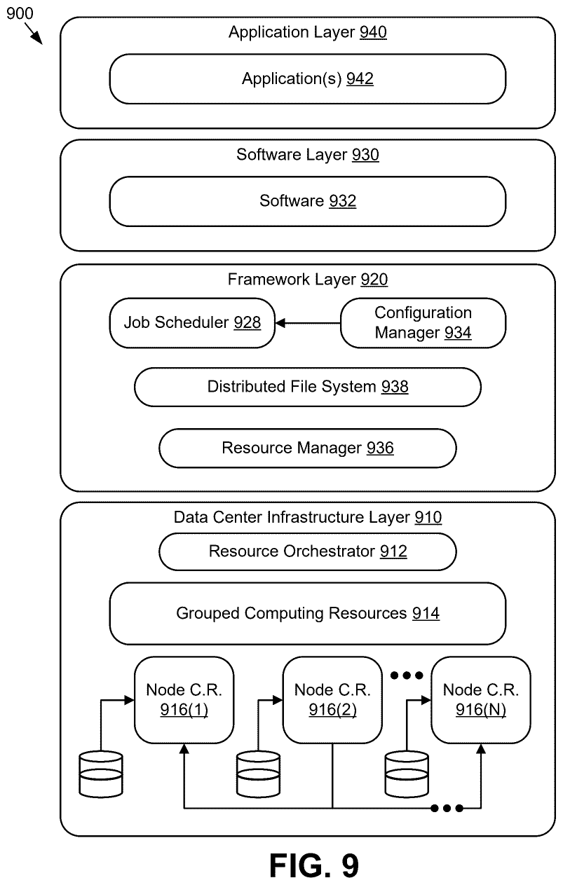

With reference to FIG. 1, FIG. 1 is an example system 100 that may be used to processing natural language queries of one or more databases, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 7A-7C), one or more computing devices or components thereof (e.g., as described in FIG. 8), and/or one or more data centers or components thereof (e.g., as described in FIG. 9).

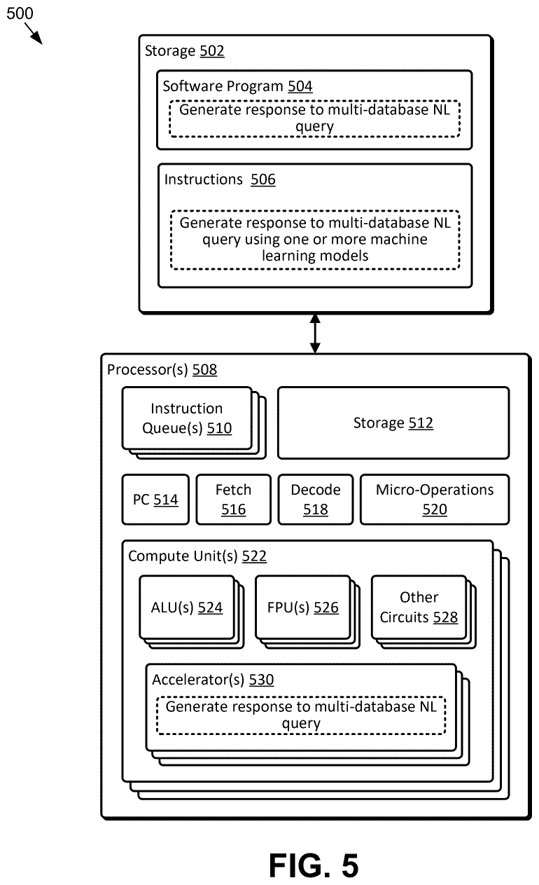

FIG. 1 illustrates a block diagram of the example system 100, in accordance with at least one embodiment. The system 100 may perform various tasks in various environments, such as factories, healthcare facilities (e.g., hospitals), offices, households, vehicles, robots, warehouses, and/or any suitable context or environment. In at least one embodiment, at least a portion of the system 100 is implemented using at least a portion of any system(s) depicted in and/or described with respect to FIGS. 5-9. In at least one embodiment, at least a portion of the system 100 is used to implement at least a portion of any system(s) depicted in and/or described with respect to FIGS. 5-9.

In at least one embodiment, the system 100 includes a computing system 102 in communication with one or more data stores (e.g., database(s), buffers, cache(s), data storage device(s), data lake(s), and/or the like), which have been illustrated as databases 120, 122, 124 in FIG. 1. In at least one embodiment, the databases 120, 122, 124 store various data, such as customer data including various formats and types of data. For example, one or more of the databases 120, 122, 124 may store video data, audio data, text data, design data, and/or other types of data. In some examples, the data stored may include text data having a format, such as Plain Text (TXT), Rich Text Format (RTF), Hypertext Markup Language (HTML), Extensible Markup Language (XML), JavaScript Object Notation (JSON), Comma-Separated Values (CSV), Markdown (MD), LaTeX (TEX), Portable Document Format (PDF), Microsoft Word Document (DOCX), ASCII, and/or others. In some examples, the data stored may include video data having a format, such as MPEG-4 Part 14 (MP4), Audio Video Interleave (AVI), QuickTime File Format (MOV), Windows Media Video (WMV), Flash Video Format (FLV), Matroska Video Format (MKV), Web Media (WEBM), Moving Picture Experts Group (MPEG), 3rd Generation Partnership Project (3GP), Advanced Video Coding High Definition (AVCHD), High Efficiency Video Coding (HEVC or H.265), Ogg Video (OGV), MPEG Transport Stream (MTS/M2TS), and/or others. In some examples, the data stored may include audio data having a format, such as MPEG-1 Audio Layer III (MP3), Waveform Audio File Format (WAV), Advanced Audio Codec (AAC), Free Lossless Audio Codec (FLAC), Windows Media Audio (WMA), Ogg Vorbis (OGG), Apple Lossless Audio Codec (ALAC), Audio Interchange File Format (AIFF), Adaptive Multi-Rate (AMR), Opus, and/or others. In some embodiments, the data may include design data (e.g., computer aided design data, 2D design data, 3D design data, and/or other types of design data), universal scene descriptor data (USD)—such as OpenUSD data—such as for Metaverse or NVIDIA's OMNIVERSE applications—or other 3D content generation and orchestration systems, and/or other types of data.

The main prompt (e.g., one or more natural language processing (NLP) queries 128) may include video data, audio data, text data, design data, and/or other types of data, such as data having any of the formats mentioned herein. The main prompt may include text data representing natural language. The main prompt may be input into the user device 126 by a user and/or provided to the computing system 102 (e.g., via the user interface 108). Additionally or alternatively, the main prompt may be generated by an automated process (e.g., a neural network, a database procedure, and/or another automated process) performed by the computing system 102 and/or another computing system, and provided to the computing system 102 and/or the database query process by the automated process or another automated process.

In at least one embodiment, the computing system 102 includes memory 104, one or more processor(s) 106, and a user interface 108. The memory 104 (e.g., one or more non-transitory processor-readable medium) may store processor executable instructions 110 that when executed by the processor(s) 106 implement a database query process 112. By way of additional non-limiting examples, the memory 104 (e.g., one or more non-transitory processor-readable medium) may be implemented, for example, using volatile memory (e.g., dynamic random-access memory (“DRAM”), random-access memory (“RAM”), and/or the like) and/or nonvolatile memory (e.g., a hard drive, a solid-state device (“SSD”), and/or the like). In at least one embodiment, at least a portion of the memory 104 is implemented using at least a portion of any system(s) depicted in and/or described with respect to FIGS. 5-9. In at least one embodiment, at least a portion of the memory 104 is used to implement at least a portion of any system(s) depicted in and/or described with respect to FIGS. 5-9.

In some embodiments, the database query process 112 is stored as instructions 110 in memory 104 may include one or more database identification models 114, one or more query translation models 116, and/or an output generator 118. In at least one embodiment, the database identification model(s) 114 may include one or more machine learning models (e.g., such as generative machine learning models) that are trained to identify one or more of the databases 120, 122, 124, from a natural language prompt.

In some embodiments, the database identification model(s) 114 may decompose the main query into sub-queries and based on the data provided in sub-queries, use various techniques, such as column classification and/or NER to identify which of the databases 120, 122, 124 to search. In some embodiments, the database identification model(s) 114 may create an output data structure (e.g., an output fusion table structure) based on the identified columns of fields of data and/or based on from which of the databases 120, 122, 124 the data originates. In some cases, the database identification model(s) 114 may be trained on database information, such as information contained in databases 120, 122, 124. In at least some embodiments, the database query process 112 may use labeled databases to train the database identification model(s) 114. In at least one embodiment, the database identification model(s) 114 may infer pseudo labels based at least in part on unlabeled data, and the database query process 112 may use the pseudo labels to train the database identification model(s) 114.

In some embodiments, the query translation model(s) 116 may include one or more machine learning models (e.g., such as generative machine learning models) that are trained to convert a natural language statement, prompt, question, and/or query into a syntax usable by an identified database, such as one of the databases 120, 122, 124, such as may be output from the database identification model(s) 114. In at least one embodiment, the query translation model(s) 116 may output one or more optimized SQL queries. The query translation model(s) 116 may be implemented using one or more LM(s), such as LLM(s), SLM(s), VLM(s), MMLM(s), etc. In some cases, the one or more query translation models 116 may be LLM(s), such as one or more SoTA (e.g., sqlcoder-7b-2), which may be trained and/or tuned on on-premise raw data. In at least one embodiment, the query translation model(s) 116 may translate, using one or more second neural networks, the two or more sub-queries into two or more database queries according to respective input formats of the two or more databases.

In some embodiments, the output generator 118 may include a function or process that formats results output by the queries run on one or more of the databases 120, 122, 124, such as according to a pattern, structure, or relationship, such as between different data, identified in the original or main prompt or query. In some cases, this may include generating an output table or other data structure that maps various results obtained from multiple ones of the databases 120, 122, 124. In some examples, the output may be referred to as a unified or combined output, where data from different databases 120, 122, 124, is output in a single data structure or table. In at least one embodiment, the output generator 118 may cause at least one of presentation or storage of the unified output.

The database query process 112 implements at least in part the database query method described herein. In at least one embodiment, the database query process 112 uses multiple machine learning processes (e.g., neural networks). For example, the database query process 112 may use one or more of the database identification model(s) 114 (e.g., one or more first neural networks) and one or more of the query translation model(s) 116 (e.g., one or more second neural networks). The database query process 112 may use the database identification model(s) 114 to identity one or more databases to direct a sub query to, which may be a part of a natural language query or prompt to search one or more of databases 120, 122, 124. The database identification model(s) 114 may output identifiers of one or more of databases 120, 122, 124. The query translation model(s) 116 may translate portions of the natural language query (e.g., referred to herein as a main query), into one or more SQL query and/or one or more queries and/or one or more database procedure(s) having one or more other appropriate syntaxes that is/are usable by a database engine to search a relevant database.

In some embodiments, the database identification model(s) 114 and/or the query translation model(s) 116 may include one or more neural networks, one or more transformer networks (e.g., Bidirectional Encoder Representations from Transformers (BERT)), one or more Long Short Term Memory (LSTM) models, one or more Convolutional Neural Networks (CNN(s)), one or more Recurrent Neural Networks (RNN(s)), one or more attention mechanisms, one or more transformers, one or more hybrid models, and/or one or more other types of neural networks—such as but not limited those described herein. In some embodiments, the database identification model(s) 114 and/or the query translation model(s) 116 may include one or more generative machine learning models, such as at least one of a large language model, a small language model, a vision language model, or a multi-modal language model.

In some embodiments, the database identification model(s) 114 and/or the query translation model(s) 116 is/are trained by the database query process 112 to infer classification, labelling, pseudo-labelling, and/or text transcription and/or translation based at least in part on input video data, audio data, design data, text, and/or one or more other types of data.

In at least one embodiment, the database identification model(s) 114 and/or the query translation model(s) 116 are part of and/or communicate with a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more MMLMs, a system implementing one or more LLMs, a system implementing one or more VLMs, a system for generating synthetic data, a system for generating synthetic data using AI, a system incorporating one or more virtual machines (VMs), a system implemented at least partially in a data center, and/or or a system implemented at least partially using cloud computing resources.

In some embodiments, the database query process 112 may train the database identification model(s) 114 and/or the query translation model(s) 116. After the database identification model(s) 114 and/or the query translation model(s) 116 are trained, the trained database identification model(s) 114 and/or the trained query translation model(s) 116 may be used to generate output, such as database identifications, database queries, translations, transcripts, summaries, labels, classifications, and/or pseudo labels. The database query process 112 may receive the output of the trained database identification model(s) 114 and the query translation model(s) 116 and use that output to perform one or more actions or other operations, such as performing a query one or more of the databases 120, 122, 124. In some embodiments, the outputs of the trained database identification model(s) 114 and the query translation model(s) 116 may use one or more machine learning processes (e.g., one or more neural networks) and/or may be provided as input to a generative language model system 700, used to train one or more machine learning processes (e.g., one or more neural networks), used to perform one or more searches, used to perform inferencing (e.g., to categorize videos, audio, and/or text, recommend similar content, identify appropriate content, etc.), used to construct indices for videos, used to determine sentiment of data (e.g., to understand how people feel about a product, service, topic, etc., for example, for market research), used to perform voice recognition training, and/or used to perform one or more other processes within one or more other types of systems. The database query process 112 may use the output of the trained database identification model(s) 114 and the query translation model(s) 116 to generate machine executable code and/or one or more instructions to send to one or more connected agents, which may move in accordance with the instruction(s). The database query process 112 may display (e.g., using a display device, for example, of the user interface 108) the output of the trained database identification model(s) 114 and the query translation model(s) 116 to one or more users (e.g., for accessibility reasons, to aid hearing impaired users, to aid in comprehension of the video, and/or the like).

The processor(s) 106 may include one or more circuits and/or processing circuitry that perform at least a portion of the instructions 110 stored in the memory 104. The processor(s) 106 may include one or more parallel processing units (“PPU(s)”), such as one or more graphics processing units (“GPU(s)”), one or more massively parallel GPU(s), and/or the like. In at least one embodiment, massively parallel GPU(s) refer to a collection of one or more GPUs, or any suitable processing units, which may be utilized to perform various processes in parallel. The processor(s) 106 may be implemented, for example, using a main central processing unit (“CPU”) complex, one or more microprocessors, one or more microcontrollers, the PPU(s) (e.g., GPU(s)), one or more data processing units (“DPU(s)”), one or more arithmetic logic units (“ALU(s)”), and/or the like. In at least one embodiment, at least a portion of the processor(s) 106 is implemented using at least a portion of any system(s) depicted in and/or described with respect to FIGS. 5-9. In at least one embodiment, at least a portion of the processor(s) 106 is used to implement at least a portion of any system(s) depicted in and/or described with respect to FIGS. 5-9.

The user interface 108 may include a display device (not shown) that a user may use to view information generated and/or displayed by the computing system 102. The user may use the user interface 108 to enter user input into the computing system 102, such as via the NLP query(ies) 128. The user interface 108 may communicate (e.g., wirelessly) with a user device 126 (e.g., a cellular telephone, a laptop computer, a tablet, and/or the like) and may receive user input, such as the NLP query(ies) 128 from the user device 126. In at least one embodiment, at least a portion of the user interface 108 is implemented using at least a portion of any system(s) depicted in and/or described with respect to FIGS. 5-9. In at least one embodiment, at least a portion of the user interface 108 is used to implement at least a portion of any system(s) depicted in and/or described with respect to FIGS. 5-9.

The processor(s) 106, the user interface 108, and/or the memory 104 may communicate with one another over one or more connection(s) 132, such as a bus, a Peripheral Component Interconnect Express (“PCIe”) connection (or bus), and/or the like. In at least one embodiment, at least a portion of the connection(s) 132 is implemented using at least a portion of any system(s) depicted in and/or described with respect to FIGS. 5-9. In at least one embodiment, at least a portion of the connection(s) 132 is used to implement at least a portion of any system(s) depicted in and/or described with respect to FIGS. 5-9.

In at least one embodiment, the computing system 102 may be a component of at least one of the databases 120, 122, 124, or vice versa. In at least one embodiment, the computing system 102 may be connected to the databases 120, 122, 124 by one or more wired and/or wireless communication links and/or connections 130. In at least one embodiment, at least a portion of the computing system 102 is implemented using at least a portion of any system(s) depicted in and/or described with respect to FIGS. 5-9. In at least one embodiment, at least a portion of the computing system 102 is used to implement at least a portion of any system(s) depicted in and/or described with respect to FIGS. 5-9. In at least one embodiment, at least a portion of the connection(s) 130 is implemented using at least a portion of any system(s) depicted in and/or described with respect to FIGS. 5-9. In at least one embodiment, at least a portion of the connection(s) 130 is implemented using at least a portion of any system(s) depicted in and/or described with respect to FIGS. 5-9.

In at least one embodiment, the databases 120, 122, 124 may be constructed using various data storage architectures and components, such as one or more relational database management systems (RDBMS), one or more NoSQL databases, one or more distributed storage systems, one or more data lakes, one or more graph databases, one or more cloud-based data warehouses, and/or one or more other types of data architectures and/or components. The databases 120, 122, 124 may store diverse types of data. The databases 120, 122, 124 may be stored in the memory 104 and may be positioned locally with respect to the computing system 102 and/or externally with respect to the computing system 102. In at least one embodiment, at least a portion of the databases 120, 122, 124 is implemented using at least a portion of any system(s) depicted in and/or described with respect to FIGS. 5-9. In at least one embodiment, at least a portion of the databases 120, 122, 124 is used to implement at least a portion of any system(s) depicted in and/or described with respect to FIGS. 5-9.

The system 100 may be used to perform a method and/or perform other operations described herein; the method may include using one or more first machine learning processes (e.g., the database identification model(s) 114) to identify one or more databases and generate at least one database identification, classification, transcription, translation, label, pseudo label, and/or output using input data (e.g., training data), and use one or more second machine learning processes (e.g., query translation model(s) 116) to generate sub-queries from a main query (e.g., the NLP query(ies) 128) in SQL or other appropriate database language that corresponds to an identified database output by the database identification models(s) 114. For example, the database query process 112, when performed by the processor(s) 106, may be used to perform the method. In at least one embodiment, at least a portion of the method may be implemented using at least a portion of any system(s) and/or any method(s) depicted in and/or described with respect to FIGS. 7A-9. In at least one embodiment, at least a portion of the method may be used to implement at least a portion of any system(s) and/or any method(s) depicted in and/or described with respect to FIGS. 7A-9.

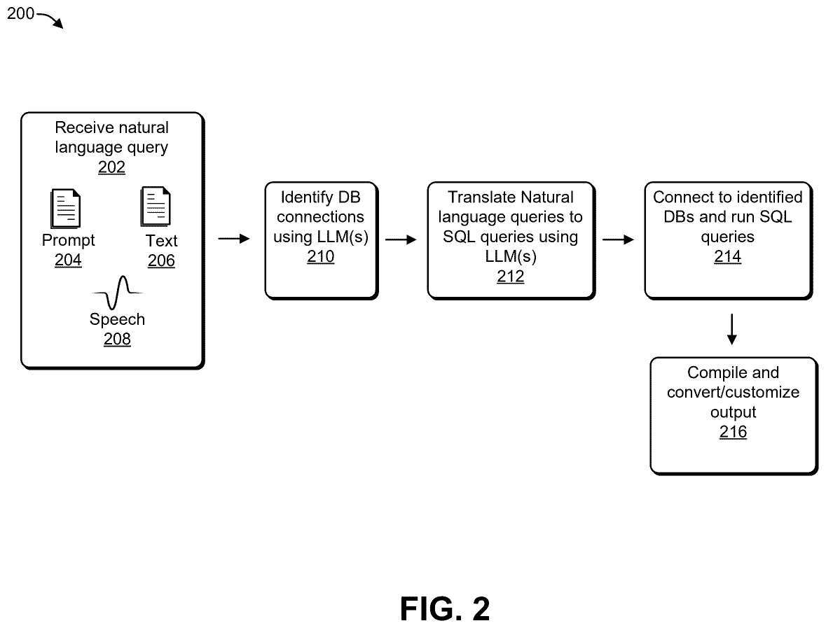

Now referring to FIG. 2, each block of a method 200, described herein, comprises a computing process that may be performed using any combination of hardware, firmware, and/or software. For instance, various functions may be carried out using one or more processors executing instructions stored in one or more memories. The method 200 may also be embodied as computer-usable instructions stored on computer storage media. The method 200 may be provided by a standalone application, a service or hosted service (standalone or in combination with another hosted service), as a microservice via an application programming interface (API) or a plug-in to another product, to name a few. In addition, the method 200 is described, by way of example, with respect to the system of FIG. 1. However, the method 200 may additionally or alternatively be executed by any one system, or any combination of systems, including, but not limited to, those described herein.

FIG. 2 is a flow diagram showing the method 200 for performing a database query using machine learning, in accordance with some embodiments of the present disclosure. The method 200, at block 202, includes receiving or obtaining a natural language query (e.g., the NLP query(ies) 128 illustrated in FIG. 1), such as of or referencing two or more different databases. In some embodiments, the natural language query received at block 202 may be an example of the NLP query(ies) 128 submitted by the user device 126, and received by the user interface 108 of the computing system 102 of system 100 described above in reference to FIG. 1. In some embodiments, referring to FIG. 2, the query received at block 202 may include or be received in one or more formats, such as a prompt 204 (e.g., provided by the user device 126 and/or the computing system 102 in response to a question presented by the user device 126 through the user interface 108), a textual query 206 (such as a request to search one or more databases), and/or speech 208, such as may be converted to text using any of a variety of speech to text conversion tools or processing. The query received at block 202 may include any type of data including semantic information, or from which semantic information may be inferred, such as text data, image data, video data, audio data, structured data, (e.g., one or more ontologies, one or more knowledge graphs, and/or other types of data) and/or others. Additionally or alternatively, the query received at block 202 may include non-semantic data, such a numerical data (e.g., sensor readings), binary data (e.g., executable files or encrypted data), and/or other types of data.

Next, at block 210, one or more database connections or identifiers may be identified. In some embodiments, block 210 may be performed using one or more LLMs or other neural networks (e.g., LM(s), SLM(s), VLM(s), MMLM(s), etc.). In some embodiments, NER may be used at block 210 to identify one or more databases. In some embodiments, block 210 may be performed by the database identification model(s) 114 described above in reference to the system 100 of FIG. 1. In some embodiments, the one or more neural networks may include one or more language models trained on database schemas, such as a variety of database schemas maintained or accessed by the system 100 of FIG. 1. In various examples, a database schema may indicate database names or descriptors, database naming conventions or patterns, column identifier, row identifiers, and other data identifiers used in the various databases, types of data maintained in a database, and so on. In at least one embodiment, the one or more neural networks may include one or more large language models (LLMs) trained on database schemas corresponding to a plurality of databases, where the plurality of databases include database types similar to the two or more databases.

Next, referring FIG. 2, at block 212, the natural language query received at block 202 may be translated into one or more sub-queries, such that each sub-query maps to one of the identified databases from block 210. Each sub-query may be translated into a corresponding syntax or language that corresponds to the identified database, such as SQL, and/or one or more other database languages. In at least one embodiment, block 202 may be performed using one or more neural networks and/or other machine learning models. In some embodiments, block 212 may be performed by the query translation model(s) 116 of the system 100 described above in reference to FIG. 1. In some embodiments, referring to FIG. 2, block 212 may convert at least a portion of the main query received at block 202 to any suitable database languages, such as SQL, NoSQL, MySQL, IBM DB2, Redis, PostgreSQL, SQLite, Microsoft SQL server, and/or one or more other languages.

Next, at block 214, a system, such as the system 100, may establish connections to the identified databases, and run or perform the translated sub-queries with respect to the identified databases to obtain results. In at least one embodiment, block 214 may be performed by the database query process 112, such as may be executed by the processor(s) 106 of the computing system 102 interfacing with two or more of the databases 120, 122, 124 described above in reference to FIG. 1.

Referring to FIG. 2, at block 216, the results obtained from the identified databases may be compiled and output. In at least one embodiment, one or more neural networks may be utilized to correlate and/or aggregate the results obtained in response to the main query received at block 202, such as in an output table (generally referred to herein as a unified output). In at least one embodiment, block 216 may be performed by the output generator 118 of the system, 100 described above in reference to FIG. 1.

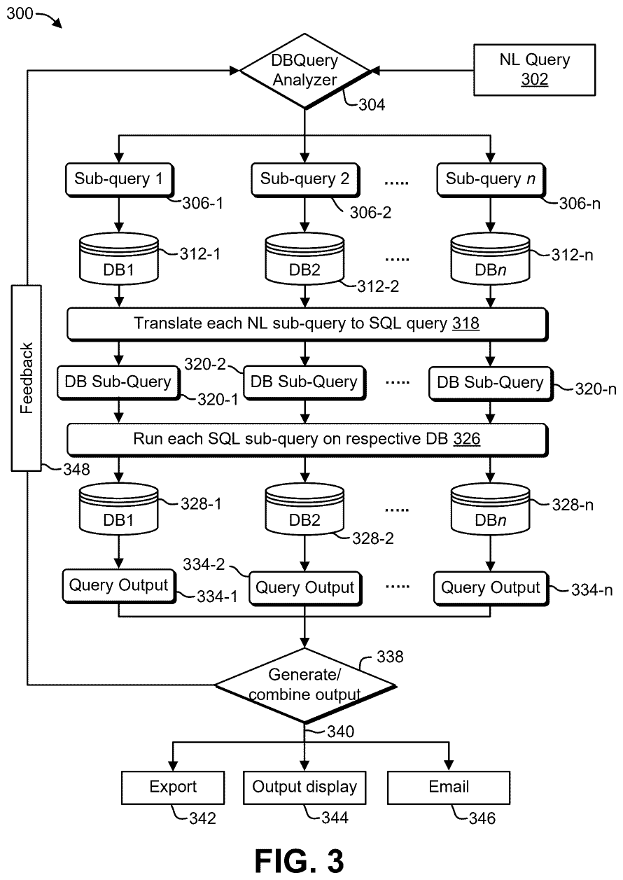

FIG. 3 illustrates a block diagram illustrating an example data flow of a process 300 for performing a database query on multiple databases using machine learning, in accordance with at least one embodiment. Now referring to FIG. 3, a DBQuery Analyzer 304 may perform one or more computing processes using any combination of hardware, firmware, and/or software. In at least one embodiment, the DBQuery Analyzer 304 performs functions of the database query process 112 described above in reference to FIG. 1. Returning to FIG. 3, in some embodiments, various functions or operations, as illustrated, may be performed by the DBQuery Analyzer 304, such as using one or more processors executing instructions stored in one or more memories. For instance, various functions implementing the DBQuery Analyzer 304 may be carried out using one or more processors (e.g., the processor(s) 106) executing instructions (e.g., the instructions 110) stored in one or more memories (e.g., the memory 104).

As illustrated, the DBQuery Analyzer 304 may receive a natural language query 302 (e.g., one of the NLP query(ies) 128), such as through a user interface (e.g., the user interface 108). In some embodiments, the natural language query may be in any of a number of different languages (e.g., human language(s), computer language(s), etc.). In some embodiments, the natural language query may include text in the form of one or more sentences, phrases, combinations of words and/or symbols, etc. In some embodiments, the DBQuery Analyzer 304 may parse the natural language query 302 into one, two, or any number of sub-queries, separated by reference to a different database, as represented by sub-queries 306-1 to 306-n, with the variable “n” representing any number of n sub-queries corresponding to different databases 312-1 to 312-n, respectively. In at least one embodiment, the DBQuery Analyzer 304 may implement the database query process 112, described above in reference to FIG. 1, including using the database identification model(s) 114 to separate the natural language query into multiple sub-queries separated by reference to different databases. While the DBQuery Analyzer 304 is described as parsing or separating the natural language query 302 into the sub-queries 306-1 to 306-n, in at least some embodiment, the natural language query 302 may generate the sub-queries 306-1 to 306-n as new queries based at least on the natural language query 302. In at least some embodiments, in addition to the natural language query 302, the DBQuery Analyzer 304 may generate the sub-queries 306-1 to 306-n based at least on the database with which each of the sub-queries 306-1 to 306-n is to be used.

In at least some embodiments, the DBQuery Analyzer 304 may translate each of the sub-queries 306-1 to 306-n (in natural language), to an SQL query (or other corresponding database language), at operation 318, to generate multiple database sub-queries 320-1 to 320-n. The DBQuery Analyzer 304 may then run or cause to be performed, each of the database sub-queries 320-1 to 320-n, on the corresponding one of databases 328-1 to 328-n, at operation 326. Running the database sub-queries 320-1 to 320-n, on the corresponding databases 328-1 to 328-n may produce query outputs 334-1 to 334-n, respectively. In some embodiments, the query outputs 334-1 to 334-n may take various forms, such as textual data, numerical data, symbols, data in a variety of different languages, machine languages, programming languages, etc., and/or various combinations thereof.

In at least some embodiments, the DBQuery Analyzer 304 may run or cause to be performed, each of the database sub-queries 320-1 to 320-n, on the corresponding one of databases 328-1 to 328-n, serially, such as based on the one or more relationships between the two or more sub-queries. For example, two sub queries may indicate that data is needed from one database to determine what data is needed form a second database. In this example, the sub-query on the second database would be run after at least partial completion of the sub-query on the first database. In at least some other embodiments, the DBQuery Analyzer 304 may run or cause to be performed, two or more of the database sub-queries 320-1 to 320-n, on the corresponding one of databases 328-1 to 328-n, in parallel or concurrently (not necessarily starting or ending at the same time, but overlapping in time), such as when one sub-query does not depend on another sub-query.

In at least some embodiments, the DBQuery Analyzer 304 may combine the results, including the query outputs 334-1 to 334-n, at operation 338 to generate a combined or unified output 340. In at least one embodiment, the output 340 may take the form of a table or other data structure, such as may be mapped to the main natural language query 302. In some embodiments, the DBQuery Analyzer 304 may use one or more neural networks to generate the mapping between the main natural language query 302 and data obtained from various databases in response to the main natural language query 302. In some embodiments, this may include mapping the data obtained to data requested in the main natural language query 302 using column classification and/or NER to generate an output table (e.g., an output fusion table structure). Stated another way, the DBQuery Analyzer 304 may determine one or more relationships between data requested in the main natural language query 302, and use one or more relationships to generate the unified or combined output 340. In some examples, the DBQuery Analyzer 304 may determine that data from two different databases, as requested in the main natural language query 302, are related, based on language identified in the main natural language query 302 that semantically links the two different databases or requests for data. For example, a query may state: “obtain data from X that corresponds to some attribute of data from Y.” In this example, the DBQuery Analyzer 304 may determine that the word “corresponds” indicates a relationship between two different sets of data identified in the query. To continue with the example, the “attribute” specified in the main natural language query 302 may indicate how the data from the two sources of databases, “X” and “Y,” are related, such as a linking value, column classifier, one or more fields, etc. In various examples, the DBQuery Analyzer 304 may use various techniques to determine relationships between data identified in the main natural language query 302 and use those relationships to generate a coherent combined or unified output (e.g., the output 340), such as through mapping data identified in the query to data to be output. The DBQuery Analyzer 304 may input the obtained results of this mapping operation and/or the query outputs 334-1 to 334-n into the data structure to generate the combined output 340.

In various examples, the output 340 of the operation 338 may then be output to one or more different channels and/or formats, such as exported in any of a variety of file formats at export operation 342, output to a display device at operation 344, and/or emailed or otherwise communicated to an address or location associated with the initial natural language query 302 at operation 346. In various examples, the DBQuery Analyzer 304 may obtain feedback 348 (e.g., the output 340), and may use that feedback to refine one or more of various aspects of the output to the natural language query 302, such as to rerun the natural language query 302 with one or more modified parameters across one or more of the databases 328-1 to 328-n to obtain different results. In some examples, the feedback 348 may include various data indicating changes to the output generated at block 338, such as refining one or more of the structure of the output (e.g., modifying one or more columns or rows of an output table), changing what data is collected to arrive at the output, such as by changing or specifying time ranges, and so on.

Now an example will be described in reference to the operations of the process 300. In at least on embodiment, the main natural language query 302 may be submitted to the system 100 (see FIG. 1) that states: “Show me the test cases executed by Neeraj Pandey and the regression bugs found due to them in last month?” The DBQuery Analyzer 304 may then use the main natural language query 302 to generate the multiple sub-queries 306-1, 306-n, such as by first identifying the different databases 312-1, 312-2 referenced in the main natural language query 302, such as a test results database and/or a developer test database. The DBQuery Analyzer 304 may use field or column classification and/or NER to identify what data in which of the databases 312-1 to 312-n to search, such as columns of data corresponding to test case data executed by Neeraj Pandey in a developer test database, and columns of data corresponding to regression bugs corresponding to the identified testcases in a test results database. The DBQuery Analyzer 304 may then translate the sub queries 306-1, 306-n into the databases sub-queries 320-1 to 320-n, and run each of the database sub-queries 320-1 to 320-n on the respective database 328-1 to 328-n, via the operation 326. Next, the DBQuery Analyzer 304 may combine the output of the database sub-queries 320-1 to 320-n into the output 340 at the operation 338, such as into a single table that shows testcase data from the developer test database correlated with regression bugs corresponding to the from the test results database. In some embodiments, the process of combining the outputs of the database sub-queries 320-1 to 320-n into the output 340 may be performed by one or more machine learning models. Finally, the output 340 may be provided to one or more users, process(es), system(s), etc. and used to perform one or more tasks, such as improving security with respect to the system 100, identifying anomalies in the data and causing one or more actions to be initiated to address the one or more anomalies, improving software quality in various ways, monitoring software updates, modifying data collection policies and/or processes, modifying data retention policies and/or processes, and various other actions that may relate to, improve, or otherwise change any operations relating to the underlying databases, and/or the query process itself.

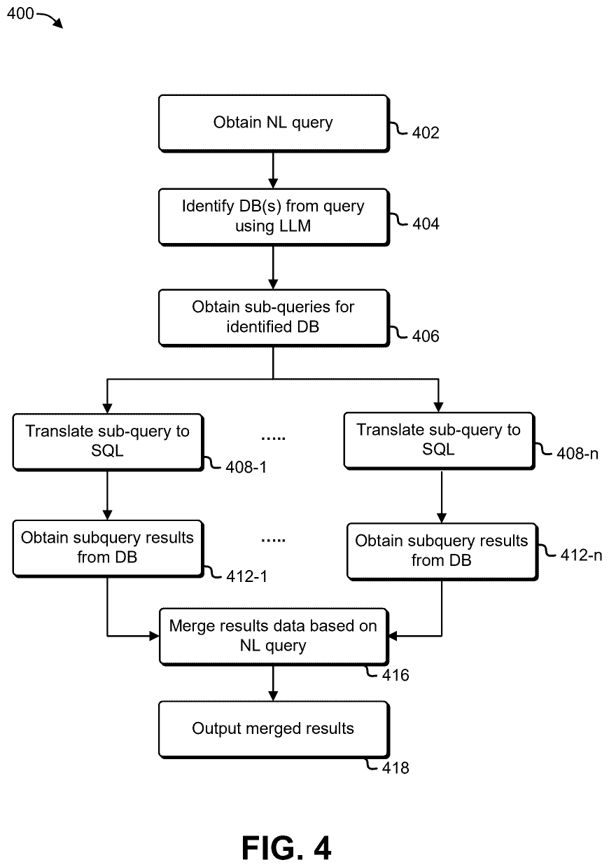

Now referring to FIG. 4, each block of a method 400, described herein, includes a computing process that may be performed using any combination of hardware, firmware, and/or software. For instance, various functions may be carried out using one or more processors executing instructions stored in one or more memories. The method 400 may also be embodied as computer-usable instructions stored on computer storage media. The method 400 may be provided by a standalone application, a service or hosted service (standalone or in combination with another hosted service), as a microservice via an application programming interface (API) or a plug-in to another product, to name a few. In addition, the method 400 is described, by way of example, with respect to the system of FIG. 1. However, the method 400 may additionally or alternatively be executed by any one system, or any combination of systems, including, but not limited to, those described herein. In some embodiments, process or method 400 may be performed by one or more of by system 100, and/or incorporate aspects of the method 200 and/or the process 300 described above in reference to FIGS. 1-3. In at least one embodiment, the method 400 may be performed at least in part by the database query process 112, and/or the DBQuery Analyzer 304 described above in reference to FIGS. 1 and 3.

FIG. 4 is a flow diagram showing the method 400 for performing a database query using machine learning, in accordance with some embodiments of the present disclosure. The method 400, at block 402, includes receiving or obtaining a natural language query, such as a query referencing two or more different databases, and/or including information that may be used to map the query to two or more different databases. In some embodiments, the natural language query received at block 402 may be an example of the NLP query(ies) 128 (see FIG. 1), the natural language query received at block 202 (see FIG. 2), and/or the natural language query 302 (see FIG. 3). In at least one embodiment, the query received at block 402 may be an example of one or more of the NLP query(ies) 128 submitted by the user device 126 (see FIG. 1), and received by the user interface 108 (see FIG. 1) of the computing system 102 (see FIG. 1) of the system 100. In some embodiments, the query received at block 402 may include and/or be received in one or more formats, such as a prompt in response to a question presented through a user interface. The query received at block 402 may be in the form of text, or text converted from speech, for example.

Next, the method 400, at block 404, includes identifying one or more database connections or identifiers using the natural language query. In some embodiments, block 404 may be performed using one or more LMs, such as LLM(s), SLM(s), VLM(s), MMLM(s), etc., or other neural networks, as described herein. In some embodiments, NER may be used at block 404 to identify one or more databases, as described herein. In some embodiments, block 404 may be performed by the database identification model(s) 114 described herein, for example, with reference to the system 100 of FIG. 1. In some embodiments, block 404 may be an example of or include one or more aspects of block 210 (see FIG. 2) described herein with reference to FIG. 2.

Next, the method 400, at block 406, includes using the main natural language query obtained at block 402 to obtain sub-queries (e.g., the sub-queries 306-1 to 306-n illustrated in FIG. 3). The sub-queries may be obtained by decomposing the main natural language query obtained at block 402 into sub-queries corresponding to the different databases identified at block 404. In some embodiments, decomposing the query may be performed using various techniques, including parsing the semantic data of the main natural language query to identify which words or phrases likely correspond to which identified database in the main natural language query. In some embodiments, the sub-queries may be obtained by parsing or separating the natural language query into the sub-queries. By way of another non-limiting embodiment, the sub-queries may be obtained by using one or more neural networks to infer the sub-queries using the natural language query obtained at block 402. In at least one embodiment, the sub-queries may be obtained by using one or more neural networks to infer the sub-queries using the natural language query obtained at block 402, as well as the database with which each of the sub-queries is to be used, and/or information related to thereto (e.g., a database name, names of fields included in the database, identifiers of one or more database indexes, identifiers of one or more database procedures, etc.).

The method 400 may include processing the sub-queries obtained at block 406 in series and/or in parallel. For ease of illustration, FIG. 4 depicts the sub-queries obtained at block 406 being processed in series by blocks 408-1 to 408-n and blocks 412-1 to 412-n. However, at least a portion of the sub-queries obtained at block 406 may be processed in series, or at least a portion of the processing of the sub-queries may be conducted in series.

The method 400, at blocks 408-1 to 408-n, may include translating each the sub-queries obtained at block 406 into a database query (e.g., an SQL query) to enable retrieval of data from the corresponding identified database. In some cases, any number of branches, such as those illustrates as beginning at blocks 408-1 to 408-n, may be performed, based on a number of sub-queries identified from the main natural language query obtained at block 402. For example, each of the blocks 408-1 to 408-n may process a different one of the sub-queries obtained at block 406 (e.g., the sub-queries 306-1 to 306-n illustrated in FIG. 3) in parallel. In various examples, the operations performed at blocks 408-1 to 408-n may include using field or column classification and/or NER to identify what data in which databases a sub-query is requesting. In some embodiments, blocks 408-1 to 408-n may be performed using one or more neural networks or models, such as one or more of the query translation model(s) 116 described above in reference to FIG. 1. In some embodiments, referring to FIG. 4, blocks 408-1 to 408-n may be examples of or include one or more aspects of block 212 described above in reference to FIG. 2.

Next, referring to FIG. 4, the method, at blocks 412-1 to 412-n, obtains data from the identified databases using the translated sub-queries obtained at blocks 408-1 to 408-n, respectively. In some embodiments, blocks 412-1 to 412-n may be examples of or include one or more aspects of block 214 described above in reference to FIG. 2.

Next, referring to FIG. 4, at block 416, the results and/or data obtained from blocks 412-1 to 412-n may be merged or combined, such as according to the main natural language query obtained at block 402. In some embodiments, merging the outputs of blocks 412-1 to 412-n may include creating and/or generating an output fusion data structure (e.g., a table) based on column classification data identified from the main natural language query, so that the data obtained from the identified databases can be presented in a format that is responsive to the main natural language query (e.g., a single table that combines the results obtained from multiple database tables in multiple databases, in a way that maintains relationships between data across the different databases).

Next, at block 418, the combined or unified results may be output, such as through one or more communications channels (e.g., email, displayed, a notification sent, etc.). In at least one embodiment, block 418 may be performed by the output generator 118 of system, 100 described above in reference to FIG. 1. By way of non-limiting example, the communications channel(s) may include the export operation 342, the operation 344 (which causes the output to be displayed using a display device), the operation 346, which causes the output or a location whereat the output may be obtained (e.g., using a selectable link) to be communicated electronically (e.g., using email, an SMS message, etc.) to an address or location associated with the initial natural language query 302, and/or other methods of communicating the output to a user and/or an automated process.

FIG. 5 illustrates an example of a system 500 that can include software and hardware to query one or more databases using machine learning, or otherwise perform any of the operations described herein, according to at least one embodiment. System 500 can include storage 502 and processor(s) 508. Storage 502 can include, for example, memory, cache, or other storage described further herein. Storage 502 can be separate from processor(s) 508, or storage 502 can be included in processor(s) 508 (e.g., in storage 512). In at least one embodiment, software program 504 and/or software libraries (or instructions) 506 can be stored in memory, cache, or other storage and provided to processor(s) 508 to cause one or more circuits of processor(s) 508 to perform operations described herein. In at least one embodiment, software program 504 and/or software libraries (or instructions) 506 can be integrated into one or more circuits of processor(s) 508. Software program 504, which can be used to perform any of the operations described herein, may be stored on storage 502.

In at least one embodiment, software program 504 can include one or more software modules. In at least one embodiment, software program 704 includes one or more modules to generate a response to a multi-database natural language query, such as using one or more machine learning models.

In at least one embodiment, as used in any implementation described herein, unless otherwise clear from context or stated explicitly to contrary, a module refers to any combination of software logic, firmware logic, hardware logic, and/or circuitry configured to provide functionality described herein. In at least one embodiment, software is embodied as a software package, code and/or instruction set or instructions, and “hardware,” as used in any implementation described herein, includes, for example, singly or in any combination, hardwired circuitry, programmable circuitry, state machine circuitry, fixed function circuitry, execution unit circuitry, and/or firmware that stores instructions performed by programmable circuitry. In at least one embodiment, modules are, collectively or individually, embodied as circuitry that forms part of a larger system, for example, an integrated circuit (IC), system on-chip (SoC), and so forth. In at least one embodiment, a module performs one or more processes in connection with any suitable processing unit and/or combination of processing units, such as one or more CPUs, GPUS, GPGPUs, PPUs, and/or variations thereof including those further described herein.

In at least one embodiment, software program 504 can include a collection of software code, commands, instructions, or other sequences of text to instruct a computing device to perform one or more computational operations and/or invoke one or more other sets of instructions, such as API(s) or API function(s) or Instruction Set Architecture (ISA) level instructions, to be executed or otherwise performed. Instructions (e.g., hardware instructions) or microcode can involve ISA level instructions, which can include native ISA instructions or non-native ISA instructions. Software program 504 and/or software libraries (or instructions) 506 (e.g., one or more modules) can be distributed among multiple processors that communicate over a bus, network, by writing to shared memory, and/or any suitable communication process such as those described herein.

In at least one embodiment, system 500 can include one or more software libraries 506 that can, for example, provide one or more APIs and/or ISA instructions. In at least one embodiment, one or more APIs and/or ISA instructions can be used to generate a response to a multi-database NL query using one or more machine learning models. In at least one embodiment, one or more software libraries 506 can be included in drivers and/or runtimes. In at least one embodiment, software libraries 506 (e.g., including one or more APIs and/or ISA instructions) can include sets of software instructions that, if executed or otherwise performed, cause processor(s) 508 to perform one or more computational operations, such as any of the operations described herein. In at least one embodiment, one or more APIs and/or ISA instructions can be distributed or otherwise provided as a part of one or more software libraries 506, runtimes, drivers, and/or any other grouping of software and/or executable code further described herein. In at least one embodiment, one or more APIs and/or ISA instructions can perform one or more computational operations in response to invocation by software program 504.

Processor(s) 508 may include any number of processors and any suitable processing unit and/or combination of processing units, such as, but not limited to, central processing units (“CPUs”), graphics processing units (“GPUs”), or other processors (including accelerators, field programmable gate arrays (FPGAs), graphics processors, parallel processors, GPGPUs, DPUs, and/or variations thereof including those further described herein), including any processors described herein, such as, but not limited to, processors in FIGS. 8-9. In at least one embodiment, processor(s) 508 can retrieve or fetch instructions (e.g., one or more APIs and/or ISA instructions) from storage 502 using, for example, instruction fetch 516 (e.g., for an Instruction Fetch stage). Instructions can include instructions to generate a response to a multi-database NL query using one or more machine learning models. In at least one embodiment, processor(s) 508 can include storage 512 and instruction queue 510 to store and queue instructions fetched from storage 502. In at least one embodiment, fetched instructions can be decoded by decode 518 to determine what operation should be performed by processor(s) 508 (e.g., in an Instruction Decode stage). In at least one embodiment, processor(s) 508 can fetch additional operands (data) that may be used for instructions, and operands can be stored, e.g., in registers or storage 512. In at least one embodiment, micro-operations 520 can perform operations on data stored in one or more registers or storage 512. For example, each step of instructions fetched by processor(s) 508 can be decomposed during execution so processor(s) 508 can execute instructions in steps through a series of micro-operations 520. In at least one embodiment, program counter (PC) 514 can hold an address for a next instruction and can be updated to point to the next instruction to be executed by processor(s) 508.

In at least one embodiment, processor(s) 508 can perform instructions (e.g., in an Execution stage). For example, processor(s) 508 can perform an operation specified by the instructions, such as an arithmetic operation, a logical operation, or a data transfer. In at least one embodiment, compute unit(s) 522 can execute instructions to perform any of the operations described herein. In at least one embodiment, compute unit(s) can include ALU(s) 524 (Arithmetic Logic Units), which may be used for performing arithmetic and logical operations. In at least one embodiment, compute unit(s) can include FPU(s) (Floating Point Units) 526, which may be used for performing floating-point calculations. In at least one embodiment, other circuits 528 can be used to perform other operations, such as vector and/or scalar operations. In at least one embodiment, accelerator(s) 530 can include one or more matrix multiplication accelerators, one or more parallel processing units (PPUs), such as GPUs, or any other accelerator or processor further described herein. In at least one embodiment, software program 504 can utilize one or more APIs and/or ISA instructions to perform various computing operations with accelerator(s) 530, such as matrix multiplication, arithmetic operations, or any other computing operation further described herein. In at least one embodiment, one or more computing operations using accelerator(s) 530 can include at least one or more groups of computing operations to be accelerated by execution at least in part by accelerator(s) 530, including to generate a response to a multi-database NL query, such as using one or more machine learning models.

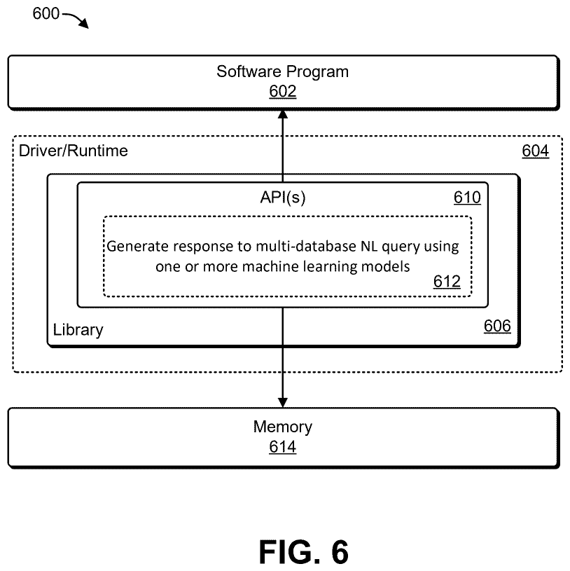

In at least one embodiment, system 500 can be used to perform one or more instructions that include functions or operations, such as those described in connection with FIGS. 1-4. In at least one embodiment, system 500 comprising one or more processors causes one or more circuits to generate a response to a multi-database NL query, such as using one or more machine learning models and/or otherwise perform operations described herein. In at least one embodiment, system 500 is included in and/or otherwise includes systems illustrated in FIGS. 1 and 3 to cause one or more circuits to generate a response to a multi-database NL query, such as using one or more machine learning models and/or otherwise perform operations described herein. In at least one embodiment, system 500 includes one or more hardware illustrated in FIGS. 6-9. such as to generate a response to a multi-database NL query, such as using one or more machine learning models and/or otherwise perform operations described herein.

FIG. 6 illustrates an example system 600 that uses one or more application programming interfaces (APIs) to query one or more databases using machine learning, according to at least one embodiment.

In at least one embodiment, system 600 is to perform optimized deployment of one or more neural networks on a plurality of platforms, computer systems, or any other hardware resources. In at least one embodiment, system 600 uses one or more first neural networks to generate one or more second versions of one or more second neural networks based, at least in part, on one or more first versions of said one or more second neural networks and one or more hardware resources to be used to perform said one or more second versions of said one or more second neural networks.

In at least one embodiment, a software program 602 is a module described in conjunction with FIG. 5. In at least one embodiment, a software program 602 comprises one or more modules. In at least one embodiment, one or more APIs 610 include said API described in conjunction with FIG. 5. In at least one embodiment, one or more APIs 610 are sets of software instructions that, if executed, cause one or more processors to perform one or more computational operations. In at least one embodiment, one or more APIs 610 refer to a reusable block of code that performs a specific task and capable of taking in data, processing it, and returning a result. In at least one embodiment, said reusable block of code refers to allowing one or more APIs 610 to be called multiple times within software program 602, potentially with different input values, to perform their designated action without needing to write same code repeatedly. In at least one embodiment, one or more APIs 610 are distributed or otherwise provided as a part of one or more libraries 606, runtimes 604, drivers 604, and/or any other grouping of software and/or executable code further described herein. In at least one embodiment, one or more APIs 610 perform one or more computational operations in response to invocation by software programs 602.

In at least one embodiment, a software program 602 is a collection of software code, commands, instructions, or other sequences of text to instruct a computing device (that includes processors such as processor 602) to perform one or more computational operations and/or invoke one or more other sets of instructions, such as APIs 610 or API functions 612, to be executed. In at least one embodiment, functionality provided by one or more APIs 610 includes software functions 612, such as those usable to accelerate one or more portions of software programs 602 using one or more parallel processing units (PPUs), such as graphics processing units (GPUs). In at least one embodiment, software program 602 includes a compiler.

In at least one embodiment, one or more APIs 610 include hardware interfaces for one or more circuits to perform one or more computational operations. In at least one embodiment, one or more software APIs 610 described herein are implemented as one or more circuits to perform one or more techniques described below in conjunction with one or more of FIG. 1 through FIG. 5. In at least one embodiment, one or more software programs 602 comprise instructions that, if executed, cause one or more hardware devices and/or circuits to perform one or more techniques described above in conjunction with one or more of FIG. 1 through FIG. 5.

In at least one embodiment, software programs 602, such as user-implemented software programs, utilize one or more APIs 610 to perform various computing operations, such as memory reservation, matrix multiplication, arithmetic operations, or any computing operation performed by parallel processing units (PPUs), such as graphics processing units (GPUs), as further described herein. In at least one embodiment, one or more APIs 610 provide a set of callable functions 612, referred to herein as APIs, API functions, and/or functions, that individually performs one or more computing operations, such as computing operations related to parallel computing. In at least one embodiment, one or more APIs 610 provide functions 612 to adjust one or more architectures of one or more neural networks based, at least in part, on one or more computing resources to use said one or more neural networks.

In at least one embodiment, one or more APIs 610 provide functions 612 to cause a neural network to perform one or more operations, such as by returning a called function to a processor where said processor invokes said neural network. In at least one embodiment, said processor includes processor(s) 602. In at least one embodiment, said neural network is one of neural networks described in conjunction with one or more of FIG. 1 through FIG. 5.

In at least one embodiment, one or more software programs 602 interact or otherwise communicate with one or more APIs 610 to perform one or more computing operations using one or more PPUs, such as GPUs. In at least one embodiment, one or more computing operations using one or more PPUs comprise at least one or more groups of computing operations to be accelerated by execution at least in part by said one or more PPUs. In at least one embodiment, one or more software programs 602 interact with one or more APIs 610 to facilitate parallel computing using a remote or local interface.

In at least one embodiment, an interface includes software instructions that, if executed, provide access to one or more functions 612 provided by one or more APIs 610. In at least one embodiment, a software program 602 uses a local interface when a software developer compiles one or more software programs 602 in conjunction with one or more libraries 606 comprising or otherwise providing access to one or more APIs 610. In at least one embodiment, one or more software programs 602 are compiled statically in conjunction with pre-compiled libraries 606 or uncompiled source code comprising instructions to perform one or more APIs 610. In at least one embodiment, one or more software programs 602 are compiled dynamically and said one or more software programs utilize a linker to link to one or more pre-compiled libraries 606 comprising one or more APIs 610.

In at least one embodiment, a software program 602 uses a remote interface when a software developer executes a software program that utilizes or otherwise communicates with a library 606 comprising one or more APIs 610 over a network or other remote communication medium. In at least one embodiment, one or more libraries 606 comprises one or more APIs 610 that are to be performed by a remote computing service, such as a computing resource service provider. In another embodiment, one or more libraries 606 comprises one or more APIs 610 are to be performed by any other computing host providing said one or more APIs 610 to one or more software programs 602. In at least one embodiment, one or more libraries 606 include Intel Math Kernel Library (MKL), Intel Data Analytics Acceleration Library (DAAL), Intel Integrated Performance Primitives (IPP), Intel Threading Building Blocks (TBB), Intel oneAPI DPC++/C++ Compiler Zen Software Studio, ROCm Hub, Vitis Software Platform, and Vitis AI.

In at least one embodiment, one or more software programs 602 utilize one or more APIs 610 to allocate and otherwise manage memory to be used by said software programs 602. In at least one embodiment, one or more software programs 602 utilize one or more APIs 610 to allocate and otherwise manage memory to be used by one or more portions of said software programs 602 to be accelerated using one or more PPUs, such as GPUs or any other accelerator or processor further described herein. Those software programs 602 request a neural network to generate one or more portions of an image based, at least in part, on one or more portions.

In at least one embodiment, one or more APIs 610 include an API to facilitate parallel computing. In at least one embodiment, an API 610 is provided by a driver and/or runtime 604. In at least one embodiment, an API 610 is provided by a CUDA user-mode driver. In at least one embodiment, an API 610 is provided by a CUDA runtime. In at least one embodiment, a driver 604 is data values and software instructions that, if executed, perform or otherwise facilitate operation of one or more functions 612 of an API 610 during load and execution of one or more portions of a software program 602. In at least one embodiment, driver 604 includes, Intel Graphics Drivers, Intel Chipset Drivers, Intel Network Adapter Drivers, Intel Audio Drivers, drivers for Intel Movidius VPUs and/or Intel Nervana neural network processors, and drivers that work with AMD Software: PRO Edition, AMD Radeon ProRender, AMD Software: Adrenalin Edition, AMD Ryzen Master Utility, and AMD StoreMI Technology, and AMD ROCm.

In at least one embodiment, a runtime 604 includes data values and software instructions that, if executed, perform or otherwise facilitate operation of one or more functions 612 of an API 610 during execution of a software program 602. In at least one embodiment, runtime 604 includes Intel Graphics Runtime, Intel one API runtime, and AMD Radeon Open Compute Platform. In at least one embodiment, one or more software programs 602 utilize one or more APIs 610 implemented or otherwise provided by a driver and/or runtime 604 to perform combined arithmetic operations by said one or more software programs 602 during execution by one or more PPUs, such as GPUs.

In at least one embodiment, one or more software programs 602 utilize one or more APIs 610 provided by a driver and/or runtime 604 to perform combine arithmetic operations of one or more PPUs, such as GPUs. In at least one embodiment, one or more APIs 610 provide combined arithmetic operations through a driver and/or runtime 604, as described above. In at least one embodiment, one or more software programs 602 utilize one or more APIs 610 provided by a driver and/or runtime 604 to allocate or otherwise reserve one or more blocks of memory 614 of one or more PPUs, such as GPUs. In at least one embodiment, one or more software programs 602 utilize one or more APIs 610 provided by a driver and/or runtime 604 to allocate or otherwise reserve blocks of memory.

To improve software programs 602 usability and/or optimization of one or more portions of said software programs 602 to be accelerated by one or more PPUs, such as GPUs, in an embodiment, one or more APIs 610 provide one or more API functions 612 to generate a response to a multi-database NL query using one or more machine learning models, such as using systems and processes described in conjunction with FIGS. 1-5. In at least one embodiment, system 600 includes a processor, comprising one or more circuits to perform one or more software programs to combine two or more APIs into a single API.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation, including classification of databases based on input training data (e.g., database names), and identifying fields or columns in databases, such as based on input database schemas input as training. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), such as those described in reference to FIGS. 5 and 6, databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query, such as any number of sub-queries obtained from a main query, as described herein. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 7A is a block diagram of an example generative language model system 700 suitable for use in implementing at least some embodiments of the present disclosure. In the example illustrated in FIG. 7A, the generative language model system 700 includes a retrieval augmented generation (RAG) component 792, an input processor 705, a tokenizer 710, an embedding component 720, plug-ins/APIs 795, and a generative language model (LM) 730 (which may include an LLM, a VLM, a multi-modal LM, etc.).

At a high level, the input processor 705 may receive an input 701 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 730 (e.g., LLM/VLM/MMLM/etc.). In some embodiments, the input 701 includes plain text in the form of one or more sentences, paragraphs, and/or documents. Additionally or alternatively, the input 701 may include numerical sequences, precomputed embeddings (e.g., word or sentence embeddings), and/or structured data (e.g., in tabular formats, JSON, or XML). In some implementations in which the generative LM 730 is capable of processing multi-modal inputs, the input 701 may combine text (or may omit text) with image data, audio data, video data, design data, USD data, and/or other types of input data, such as but not limited to those described herein. Taking raw input text as an example, the input processor 705 may prepare raw input text in various ways. For example, the input processor 705 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 705 may remove stopwords to reduce noise and focus the generative LM 730 on more meaningful content. The input processor 705 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 792 (which may include one or more RAG models, and/or may be performed using the generative LM 730 itself) may be used to retrieve additional information to be used as part of the input 701 or prompt. RAG may be used to enhance the input to the LLM/VLM/MMLM/etc. with external knowledge, so that answers to specific questions or queries or requests are more relevant—such as in a case where specific knowledge is required. The RAG component 792 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 701 may be generated using the query or input to the model (e.g., a question, a request, etc.) in addition to data retrieved using the RAG component 792. In at least one embodiment, input 701 may include database names, database schema, natural language queries, sub-queries, and or other data, as described above in reference to FIG. 1-6. For example, one or more models trained using one or more database identification models may receive a natural language database query as input 701, whereby the generative LLM 730 may generate one or more database names and/or separate the natural language query into two or more sub-queries based corresponding to the identified database names. In another example, one or more models trained using one or more query translation models, may receive one or mor sub-queries as input 701, whereby the generative LLM 730 may generate one or more translated sub-queries into a database syntax, such as SQL. In another example,, one or more models trained using natural language quires, column or field classification form various databases, and/or named entity recognition may receive a natural language query as input 701, whereby the generative LLM may generate an output data structure or relationship to which to map the data obtained from the sub-queries to produce a unified output as a response to the natural language query. In some embodiments, the input processor 705 may analyze the input 701 and communicate with the RAG component 792 (or the RAG component 792 may be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 792 may retrieve a prior stored conversation history—or at least a summary thereof—and include the prior conversation history along with the current ask/request as part of the input 701 to the generative LM 730.

The RAG component 792 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 792 and the embeddings of the chunks along with the embeddings of the query may be compared to identify the most similar/related embeddings to the query, which may be supplied to the generative LM 730 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 792 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 710 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy may depend on factors such as the language being processed, the task at hand, and/or characteristics of the training dataset. As such, the tokenizer 710 may convert the (e.g., processed) text into a structured format according to tokenization schema being implemented in the particular embodiment.

The embedding component 720 may use any known embedding technique to transform discrete tokens into (e.g., dense, continuous vector) representations of semantic meaning. For example, the embedding component 720 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data/video data/etc., the input processor 701 may resize the data to a standard size compatible with format of a corresponding input channel and/or may normalize pixel values to a common range (e.g., 0 to 1) to ensure a consistent representation, and the embedding component 720 may encode the image data using any known technique (e.g., using one or more convolutional neural networks (CNNs) to extract visual features). In some implementations in which the input 701 includes audio data, the input processor 701 may resample an audio file to a consistent sampling rate for uniform processing, and the embedding component 720 may use any known technique to extract and encode audio features—such as in the form of a spectrogram (e.g., a mel-spectrogram). In some implementations in which the input 701 includes video data, the input processor 701 may extract frames or apply resizing to extracted frames, and the embedding component 720 may extract features such as optical flow embeddings or video embeddings and/or may encode temporal information or sequences of frames. In some implementations in which the input 701 includes multi-modal data, the embedding component 720 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 730 and/or other components of the generative LM system 700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 720 may apply an encoded representation of the input 701 to the generative LM 730, and the generative LM 730 may process the encoded representation of the input 701 to generate an output 790, which may include responsive text and/or other types of data.

As described herein, in some embodiments, the generative LM 730 may be configured to access or use—or capable of accessing or using—plug-ins/APIs 795 (which may include one or more plug-ins, application programming interfaces (APIs), databases, data stores, repositories, etc.). For example, for certain tasks or operations that the generative LM 730 is not ideally suited for, the model may have instructions (e.g., as a result of training, and/or based on instructions in a given prompt, such as those retrieved using the RAG component 792) to access one or more plug-ins/APIs 795 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 795 to the plug-in/API 795, the plug-in/API 795 may process the information and return an answer to the generative LM 730, and the generative LM 730 may use the response to generate the output 790. This process may be repeated—e.g., recursively—for any number of iterations and using any number of plug-ins/APIs 795 until an output 790 that addresses each ask/question/request/process/operation/etc. from the input 701 can be generated. As such, the model(s) may not only rely on its own knowledge from training on a large dataset(s) and/or from data retrieved using the RAG component 792, but also on the expertise or optimized nature of one or more external resources—such as the plug-ins/APIs 795.

FIG. 7B is a block diagram of an example implementation in which the generative LM 730 includes a transformer encoder-decoder. For example, assume input text such as “Who discovered gravity” is tokenized (e.g., by the tokenizer 710 of FIG. 7A) into tokens such as words, and each token is encoded (e.g., by the embedding component 720 of FIG. 97A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 735 of the generative LM 730.

In an example implementation, the encoder(s) 735 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 740 may convert the context vector into attention vectors (keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 735, in an example transformer architecture, each token (e.g., word) flows through a separate path in the decoder(s) 745. During a first pass, the decoder(s) 745, a classifier 750, and a generation mechanism 755 may generate a first token, and the generation mechanism 755 may apply the generated token as an input during a second pass. The process may repeat in a loop, successively generating and adding tokens (e.g., words) to the output from the preceding pass and applying the token embeddings of the composite sequence with positional encodings as an input to the decoder(s) 745 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 735, except that it creates its queries from the layer below it and takes the keys and values (e.g., matrix) from the output of the encoder(s) 735.

As such, the decoder(s) 745 may output some decoded (e.g., vector) representation of the input being applied during a particular pass. The classifier 750 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 755 may select or sample a word or token based on a corresponding predicted probability (e.g., select the word with the highest predicted probability) and append it to the output from a previous pass, generating each word or token sequentially. The generation mechanism 755 may repeat the process, triggering successive decoder inputs and corresponding predictions until selecting or sampling a symbol or token that represents the end of the response, at which point, the generation mechanism 755 may output the generated response.

FIG. 7C is a block diagram of an example implementation in which the generative LM 730 includes a decoder-only transformer architecture. For example, the decoder(s) 760 of FIG. 7C may operate similarly as the decoder(s) 745 of FIG. 7B except each of the decoder(s) 760 of FIG. 7C omits the encoder-decoder self-attention layer (since there is no encoder in this implementation). As such, the decoder(s) 760 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 760. As with the decoder(s) 745 of FIG. 7B, each token (e.g., word) may flow through a separate path in the decoder(s) 760, and the decoder(s) 760, a classifier 765, and a generation mechanism 770 may use auto-regression to sequentially generate one token at a time until predicting a symbol or token that represents the end of the response. The classifier 765 and the generation mechanism 770 may operate similarly as the classifier 750 and the generation mechanism 755 of FIG. 7B, with the generation mechanism 770 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

In at least one embodiment, memory 804 may implement or be implemented by memory 104 such as that described above in conjunction with FIG. 1. In at least one embodiment, CPU(s) 806 and/or GPU(s) 808 may implement or be implemented by the processor(s) 106 such as those described above in conjunction with FIG. 1. In at least one embodiment, memory 804 stores input to and/or output from one or more language models and may be used in conjunction with one or more models trained using one or more of the database query methods 200, 300, and/or 400 (e.g., implemented by the database query process 112), and/or other methods such as those described in conjunction with FIGS. 1-4. For example, one or more CPU(s) 806 and/or GPU(s) 808 may implement one or more of the database query methods 200, 300, and/or 400 described in conjunction with FIGS. 1-4.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMS), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, application layer 940, software layer 930, framework layer 920 and/or data center infrastructure layer 910 perform(s) one or more portions of database equerry process of functionality 112, the labeled processing functionality 120, and/or one or more stages and/or methods described in conjunction with FIGS. 1-4.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments-in which case a server may not be included in a network environment—and one or more client-server network environments-in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

At least one embodiment of the disclosure can be described in view of the following clauses:
1. A system comprising one or more processors to at least:
identify, using one or more first neural networks and based at least on a natural language query, two or more databases;
obtain, using the one or more first neural networks and based at least on the natural language query, two or more sub-queries;
translate, using one or more second neural networks, the two or more sub-queries into two or more database queries according to respective input formats of the two or more databases;
obtain results from the two or more databases based at least on executing the two or more database queries with respect to the two or more databases;
merge the obtained results into a unified output based at least on one or more relationships between the two or more sub-queries determined based at least on the natural language query; and
cause at least one of presentation or storage of the unified output.
2. The system of clause 1, wherein the one or more processors are to at least:
identify, using one or more third neural networks, one or more column classifications for individual databases of the two or more databases.
3. The system of clause 1 or 2, wherein the one or more processors are to at least:
merge the obtained results into the unified output based at least on the one or more identified column classifications identified for at least one database of the two or more databases.
4. The system of any of clauses 1-3, wherein the one or more second neural networks comprise one or more large language models (LLMs) trained on database schemas corresponding to a plurality of databases, wherein the plurality of databases include database types similar to the two or more databases.
5. The system of any of clauses 1-4, wherein the one or more processors are to at least:
execute the two or more database queries with respect to the two or more databases concurrently based at least on the one or more relationships between the two or more sub-queries.
6. The system of any of clauses 1-5, wherein the one or more processors are to at least:
execute the two or more database queries on the two or more databases serially based at least on the one or more relationships between the two or more sub-queries.
7. The system of claim any of clauses 1-6, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
8. One or more processors comprising processing circuitry to:
in response to a natural language query, obtain two or more sub-queries and identify two or more databases respectively corresponding to individual sub-queries of the two or more sub-queries;
use one or more first neural networks to obtain two or more database queries based at least on the two or more sub-queries;
merge, based at least on one or more relationships between the two or more sub-queries, results obtained from executing the two or more database queries with respect to the two or more databases into a data structure; and
cause at least one of saving the data structure or output corresponding to the data structure.
9. The one or more processors of clause 8, wherein the processing circuitry is to:
use the natural language query to identify the two or more databases.
10. The one or more processors of clauses 8 or 9, wherein the processing circuitry is to:
identify the two or more databases based at least on the natural language query and to obtain the two or more sub-queries based at least on performing at least one of named entity recognition or column classification using the natural language query.
11. The one or more processors of any of clauses 8-10, wherein the processing circuitry is to:
use one or more third neural networks to identify one or more column classifications for individual databases of the two or more databases, wherein the identified one or more column classifications are used to determine the one or more relationships between the two or more sub-queries.
12. The one or more processors of any of clauses 8-11, wherein the processing circuitry is to:
execute the two or more database queries on the two or more databases concurrently based on the one or more relationships between the two or more sub-queries.
13. The one or more processors of any of clauses 8-12, wherein the data structure comprises a fusion table and is generated based at least on one or more identified column classifications for at least one database of the two or more databases.
14. The one or more processors of any of clauses 8-13, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
15. A method comprising:
generating a response to a query based at least on executing a plurality of sub-queries with respect to a plurality of databases having different query-format requirements, the plurality of sub-queries generated based at least on a generative machine learning model processing the query and information corresponding to database types of the plurality of databases.
16. The method of clause 15, wherein the generative machine learning model uses the query to identify the plurality of databases and the information.
17. The method of clauses 15 or 16, wherein the generative machine learning model includes at least one of a large language model, a small language model, a vision language model, or a multi-modal language model.
18. The method of any of clauses 15-17, wherein the response to the query includes a combined output of a plurality of responses to the plurality of sub-queries.
19. The method of any of clauses 15-18, wherein the response is output as raw data obtained from the two or more databases in response to the plurality of sub-queries.
20 The method of any of clauses 15-19, wherein the method is performed by at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

1. A system comprising one or more processors to at least:
identify, using one or more neural networks and based at least on a natural language query, two or more databases of two or more different database types:
obtain, using the one or more neural networks and based at least on the natural language query, two or more sub-queries;
translate, using the one or more neural networks, the two or more sub-queries into two or more database queries according to respective input formats of the two or more databases;
obtain results from the two or more databases based at least on executing the two or more database queries with respect to the two or more databases;
merge the obtained results into a unified output based at least on one or more relationships between the two or more sub-queries determined based at least on the natural language query; and
cause at least one of presentation or storage of the unified output.

2. The system of claim 1, wherein the one or more processors are to at least:
identify, using one or more second neural networks, one or more column classifications for individual databases of the two or more databases.

3. The system of claim 2, wherein the one or more processors are to at least:
merge the obtained results into the unified output based at least on the one or more identified column classifications identified for at least one database of the two or more databases.

4. The system of claim 1, wherein the one or more neural networks comprise one or more large language models (LLMs) trained on database schemas corresponding to a plurality of databases, wherein the plurality of databases include database types similar to the two or more different database types.

5. The system of claim 1, wherein the one or more processors are to at least:
execute the two or more database queries with respect to the two or more databases concurrently based at least on the one or more relationships between the two or more sub-queries.

6. The system of claim 1, wherein the one or more processors are to at least:
execute the two or more database queries on the two or more databases serially based at least on the one or more relationships between the two or more sub-queries.

7. The system of claim 1, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

8. One or more processors comprising processing circuitry to:
in response to a natural language query, obtain two or more sub-queries and identify two or more databases of two or more different database types respectively corresponding to individual sub-queries of the two or more sub-queries;
use one or more neural networks to obtain two or more database queries based at least on the two or more sub-queries;
merge, based at least on one or more relationships between the two or more sub-queries, results obtained from executing the two or more database queries with respect to the two or more databases into a data structure; and
cause at least one of saving the data structure or output corresponding to the data structure.

9. The one or more processors of claim 8, wherein the processing circuitry is to:
use the natural language query to identify the two or more databases.

10. The one or more processors of claim 8, wherein the processing circuitry is to:
identify the two or more databases based at least on the natural language query and to obtain the two or more sub-queries based at least on performing at least one of named entity recognition or column classification using the natural language query.

11. The one or more processors of claim 8, wherein the processing circuitry is to:
use one or more second neural networks to identify one or more column classifications for individual databases of the two or more databases, wherein the identified one or more column classifications are used to determine the one or more relationships between the two or more sub-queries.

12. The one or more processors of claim 8, wherein the processing circuitry is to:
execute the two or more database queries on the two or more databases concurrently based on the one or more relationships between the two or more sub-queries.

13. The one or more processors of claim 8, wherein the data structure comprises a fusion table and is generated based at least on one or more identified column classifications for at least one database of the two or more databases.

14. The one or more processors of claim 8, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

15. A method comprising:
generating a response to a query based at least on executing a plurality of sub-queries with respect to a plurality of databases of two or more different database types and having different query-format requirements, the plurality of sub-queries generated based at least on a generative machine learning model processing the query and information corresponding to the two or more different database types of the plurality of databases.

16. The method of claim 15, wherein the generative machine learning model uses the query to identify the plurality of databases and the information.

17. The method of claim 15, wherein the generative machine learning model includes at least one of a large language model, a small language model, a vision language model, or a multi-modal language model.

18. The method of claim 15, wherein the response to the query includes a combined output of a plurality of responses to the plurality of sub-queries.

19. The method of claim 15, wherein the response is output as raw data obtained from the two or more databases in response to the plurality of sub-queries.

20. The method of claim 15, wherein the method is performed by at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
